(19) United States
(12) Patent Application Publication
(10) Pub. No.: US 2006/0060089 A1
(43) Pub. Date: Mar. 23, 2006

(54) Treatment of liquids

(76) Inventor: Richard John Sugden, Bega (AU)

Correspondence Address: RICHARD J. SUGDEN, ''SPRINGFIELD'' R.M.B. 1665, PRINCES HIGHWAY, BEGA, 2550, AU

(21) Appl. No.: 10/994,933

(22) Filed: Nov. 23, 2004

(30) Foreign Application Priority Data
Sep. 21, 2004 (AU) 2004212592

(51) Int. Cl. C12G 1/02

(52) U.S. Cl. 99/277

(57) ABSTRACT

A treatment chamber 20 for a liquid, in particular a beverage such as wine, is disclosed. The chamber consists of opposed walls 29 and 3 which are permeable to the surrounding air but substantially impermeable to the liquid being treated. These walls are made from resiliently tensioned oak planks or other semi-permeable material. The illustrated example shows spring loaded oak planks 31 being used to form the opposing walls 29 and 3.

The liquid is circulated from a reservoir through the space 21 between the opposed walls and back into the reservoir such that a transfer of flavourant compounds or air takes place into the liquid being circulated.

### CROSS-REFERENCE to RELATED APPLICATIONS

This application is a CONTINUATION IN PART to application Ser. No. 10/177,342 which has its priority date as 30 Dec. 1999.

New material in this application claims its priority date from an AUSTRALIAN “Patent of Addition” application number 2004212592, (certified copy enclosed) made on the 21 Sep. 2004 which derives its priority date from provisional application number 2003907104 dated 23 Dec. 2003.

### STATEMENT REGARDING FEDERALLY SPONSORED RESEARCH AND DEVELOPMENT

Not Applicable.

### REFERENCE TO SEQUENCE LISTING etc.

Not Applicable.

### BACKGROUND OF THE INVENTION

This invention relates to treatment of liquids. More particularly, the invention relates to an apparatus and method for the treatment of liquids, including in particular wine and other beverages.

The invention has been devised specifically, although not solely, for the treatment of wine for flavouring and/or ageing therof. However, it should be appreciated that the invention may find application to treatment of other beverages, as well as to other liquids generally.

### BACKGROUND ART

Storage of wine and other beverages in wood barrels, often fashioned from oak wood, has traditionally been used to bring about an improvement in flavour through the slow diffusion of air through the wood, causing various chemical changes to the contents and also the leaching of some flavourant compounds into the wine or beverage from the wood.

The traditional wood barrel is difficult to clean and inspect and requires replacement regularly at considerable cost.

Attempts have been made to overcome some of these problems by dismantling the barrel and shaving wood form inside the staves or by fitting extra pieces of wood inside to release flavourant compounds.

Dismantling a conventional barrel to either shave the staves or add extra pieces of wood requires a reasonably high level of skill and has the added disadvantage that replacement of outer wood, which may be infected with undesirable micro-organisms or have unwanted colour or flavour from its previous contents does not occur.

A square vat with oak sides has been tried but this still requires wine or must be transferred from tanks into the vat, which must then be lifted and stacked. These units also require cleaning and topping regularly, as with conventional barrels. These vats offer no acceleration of rate of transfer of flavourant compounds from the oak to the wine or beverage.

Other attempts have included the fitting of oak planks inside wine tanks to release flavourant compounds into the wine.

This method derives oak flavour but does not soften or age the wine as does a barrel as no diffusion of air takes place. It suffers from the added disadvantage that workers must enter the enclosed space of a wine tank to fix or remove the planks. This requires training, gas monitoring, safety equipment and a safety observer outside the tank.

The most closely related art is described in the PARANT Patent Application, Ser. No. 10/177,342

This describes a flavouring plate which is incorporated in a circulatory system, wine being moved past a flat plate made of spring-loaded oak timber or other semi-permeable material and also patent number 10-1963, a whiskey ageing vat by Kelley.

This disclosure removes any ambiguity which may arise about the nature of the backing plate used to increase the surface area of the exchange surface.

### DISCLOSURE OF THE INVENTION

According to this invention, there is provided a method of treatment of a liquid (such as a beverage including in particular wine) by moving the liquid undergoing treatment through a chamber, opposing boundary walls of which are defined by surfaces formed of resiliently tensioned oak planks or other semi-permeable material, permeable to air yet substantially impermeable to the liquid, the outer faces of these walls being exposed to air.

Preferably, the method includes circulating the liquid around a circulation path, during which the liquid moves through the chamber, opposing boundary walls of which are defined by said walls.

Preferably, the chamber comprises a treatment space defined between a pair of spaced apart boundary walls, both of which are defined by said walls.

Preferably, said means comprises a circulation path around which the liquid is circulated.

Preferably, the circulation path includes a reservoir such as a tank.

Preferably, the treatment liquid is passed through a treatment chamber, between a pair of spaced apart boundary walls, such walls being permeable to air yet substantially impermeable to liquid, the outer side of each wall is exposed to air.

### BRIEF DESCRIPTION OF THE DRAWINGS

The invention will be better understood by reference to the following description:

FIG. 1 is a schematic elevational view of a treatment chamber forming part of the apparatus.

FIG. 2 is a sectional view on line 2-2 of FIG. 1.

FIG. 3 is a perspective view of the treatment chamber.

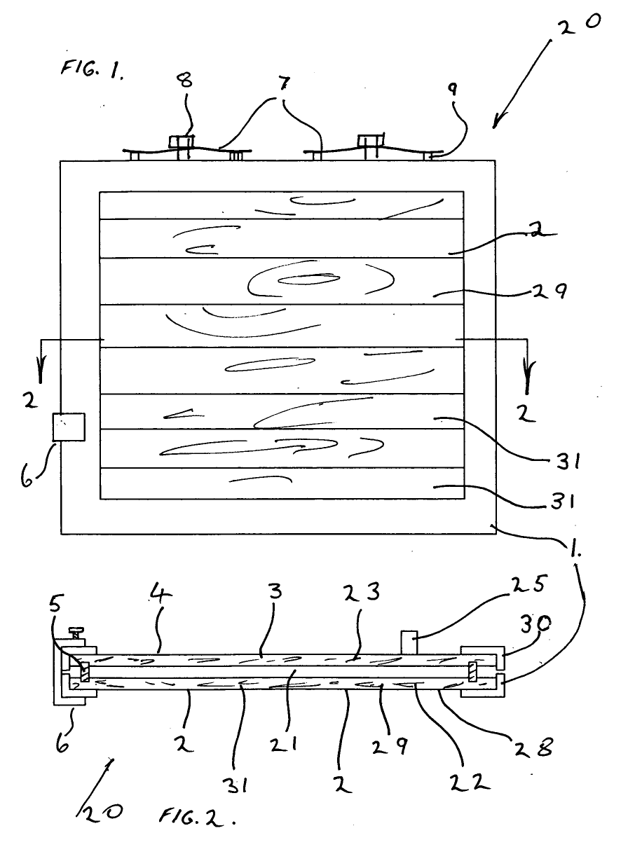

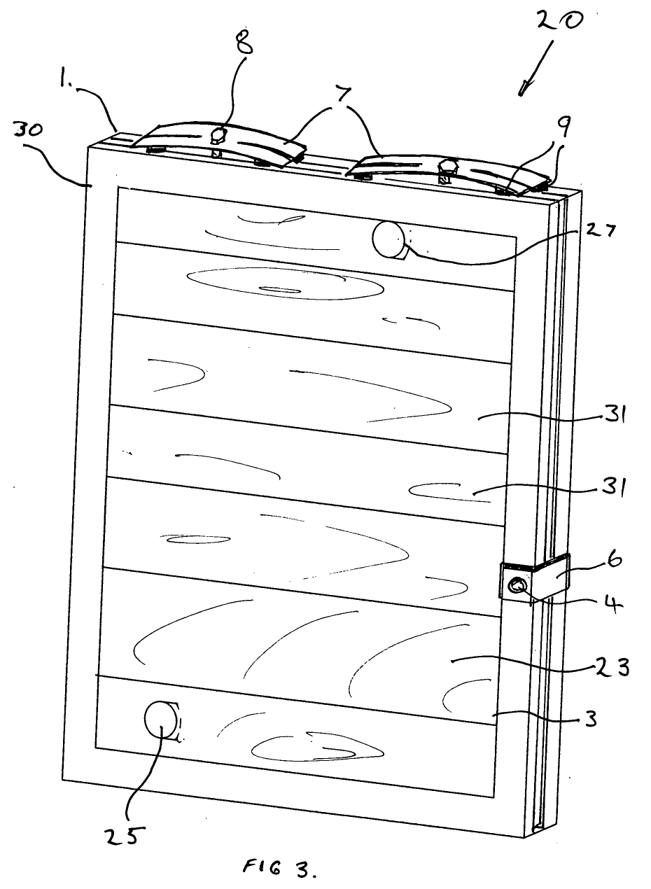

### BEST MODE FOR CARRYING OUT THE INVENTION

The device comprises a treatment plant (not shown) having a tank (also not shown) defining a reservoir for containing wine undergoing treatment. The tank is incorporated in a treatment path around which the wine is circulated. The treatment path includes at least one, and preferably a series of, treatment chambers 20 through which the wine is passed for the purposes of flavouring and ageing.

The treatment chamber 20 comprises a space 21 defined between a pair of spaced apart confronting surfaces 22, 23. The space 21 is sealed against egress of wine, apart from an inlet 25 and outlet 27.

In this embodiment, the surfaces 22 and 23 are defined by walls 29 and 3 assembled from a plurality of elements 31. In this embodiment, the elements 31 comprise planks 2 of wood suitable for flavouring the wine, such as oak. The assembly of oak planks 2 form the walls 29 and 3 which are substantially impermeable to wine but permeable to air. The outer sides 28 and 4 of the walls 29 and 3 are exposed to ambient air which can permeate through the planks for the purpose of ageing the wine. Flavours in the oak can also permeate into the wine for the purposes of flavouring the wine.

The treatment chamber 20 is defined by a vessel of a construction comprising galvanized steel angle frames 1, 30 containing straight oak planks 2 arranged such that each plank abuts the next.

Pressure springs 7 and pressure spring bolt 8 exert sufficient pressure through spring studs 9, (which pass through frames 1 and 30) against a steel pressure strip (not visible) which presses against oak planks 2 such that each oak plank forms a fluid seal with the adjacent plank.

Held tightly against the oak planks 2 is the opposing wall of oak planks 3.

The galvanized steel retaining frames are held tightly in place by a number of retaining clamps 6. For convenience only one retaining clamp is shown.

A fluid seal between the oak planks 2 and opposing wall 3 is ensured by having a pliable gasket 5 fitted between the two.

Wine or beverage is pumped from a tank (not shown) though the narrow space 21 formed between the wall 2 and backing wall 3 via the inlet and outlet 25 and 27 and then back into the tank.

There can be a single treatment chamber or a plurality of such chambers, preferably arranged in series.

The treatment chamber, or series of treatment chambers, may be located within a cool room or a humidity controlled area.

Improvements and modifications may be incorporated without departing from the scope of the invention.

The springs 7 used to ensure a seal between adjacent oak planks are not limited to leaf springs as shown, but may be of any form or material. This may include material in compression, torsion or tension and be a firmsetting polymer in compression or rods in tension or any other means of resilient tensioning to ensure a fluid seal between elements whose dimensions may change when wetted with the treatment liquid.

It should be appreciated that the scope of the invention is not limited to the scope of the embodiment described.

Throughout the specification, unless the context requires other wise, the word “comprise” or variations such as “comprises” or “comprising” will be understood to imply the inclusion of a stated integer or group of integers but not the exclusion of any other integer or group of integers.

1. A treatment chamber for a liquid, such as a beverage including in particular wine, is disclosed which consists of a treatment space defined between a pair of spaced apart walls, both walls consisting of resiliently tensioned oak planks or other semi-permeable material, through which the liquid is circulated around a circulation path from a reservoir through the space between the walls and back into the reservoir such that a transfer of flavourant compounds or air takes place from the spaced apart walls into the liquid being circulated.
